(19) United States
(12) Patent Application Publication
(10) Pub. No.: US 2010/0140846 A1
(43) Pub. Date: Jun. 10, 2010

(54) COMPOSITION BASED UPON A POLYAMIDE THAT IS AMORPHOUS AND TRANSPARENT OR HAS VERY LOW CRYSTALLINITY, AND UPON A COPOLYAMIDE WITH ETHER AND AMIDE UNITS

(75) Inventors: Thibaut Montanari, Menneval (FR); Philippe Blondel, Bernay (FR)

Correspondence Address: ARKEMA INC.;PATENT DEPARTMENT - 26TH FLOOR, 2000 MARKET STREET, PHILADELPHIA, PA, 19103-3222, US

(73) Assignee: Arkema France, Colombes (FR)

(21) Appl. No.: 12/304,167

(22) PCT Filed: Jun. 8, 2007
(86) PCT No.: PCT/FR2007/051394

§ 371 Date: Nov. 16, 2009

(30) Foreign Application Priority Data
Jun. 14, 2006 (FR) 0605285
Aug. 16, 2006 (US) 60838010

(51) Int. Cl. C08J 5/18; C08L 77/00; C08L 77/06

(52) U.S. Cl. 264/331.19; 525/418; 525/432; 524/538

(57) ABSTRACT

“Composition composed of a mixture of: 60 to 99% by weight of a polymer component (A) formed from at least one of the homopolyamides and copolyamides: a) that are transparent and amorphous or present crystallinity such that the enthalpy of fusion during the second heating of an DSC ISO (delta Hm(2) is at most 30 J/g, the mass being related to the number of amide units contained or polyamide contained, this melting corresponding to that of the amide units; b) presenting a glass transition temperature (Tg) of greater than 90° C.; and c) composed at least in part of cycloaliphatic and/or aromatic units, and/or alloys based on at least one previously cited homopolyamide or copolyamide, said alloys being amorphous or presenting crystallinity meeting the same definition as hereinabove; 40 to 1% by weight of a polymer component (B) formed by at least one copolyamide based on ether units and amide units; the polymer components (A)+(B) representing 100% by weight; where at least one among (A) and (B) may additionally contain at least one additive usual for thermoplastic polymers and copolymers, without the content of said additive or additive(s) in each of the polymer components (A) and (B) representing more than 30% by weight of the said polymer component.”

The present invention relates to a composition based on transparent polyimide which is amorphous or of very low crystallinity and on copolyamide comprising ether units and comprising amide units.

Transparent polyamides which are amorphous or those which are only very slightly crystalline, that is to say for which the enthalpy of fusion during the second heating of an ISO DSC (delta Hm(2)) is at most equal to 10 J/g, indeed even 30 J/g (case of “Trogamid CX7323” mentioned below), are materials which exhibit the following advantages: high transparency, very good thermomechanical behaviour (high heat deflection temperature (HDT) due to the high glass transition temperature (Tg), which is greater than 90° C.), fairly good impact strength, fairly good chemical resistance and fairly good stress cracking resistance better than that of other common transparent amorphous polymers, such as polycarbonate, polystyrene or poly(methyl methacrylate).

Mention may be made, as examples of transparent polyamides which are amorphous or only very slightly crystalline, subsequently abbreviated to TR am PA, of those sold by Arkema under the names “Cristamie MS 1700”, Rilsan Clear® G350 and Platamid HX2507®”, by Ems under the name “Grilamid TR90”, by Degussa under the name “Trogamid CX 7323” and by Lanxess under the name “Dureathan T40”.

TABLE 1

| NAME | COMPOSITION |
|---|---|
| Cristamid MS 1700 | PA-B.T/B.I/12 |
| Rilsan Clear ®^{G350} | B.14 |
| Platamid HX2507 | 12/IPD.10 |
| Grilamid TR90 | B.12 |
| Trogamid CX 7323 | P.12 |
| Dureathan T40 | PA-6.I/6.T |

In the formulae of the above Table 1, the abbreviations correspond to:
B=BMACM=bis(3-methyl-4-aminocyclohexyl)methane
P=PACM=para-aminodicyclohexylmethane
IPD=isophoronediamine
I=isophthalic acid
T=terephthalic acid
6=hexamethylenediamine
10=1,10-decanedioic acid
12=1,12-dodecanedioic acid
14=1,14-tetradecanedioic acid
12=lauryllactam

These transparent polyamides which are amorphous or only very slightly crystalline exhibit, however, the following disadvantages:
fairly problematic ability to be injection moulded, due to their high viscosity (if they are chosen as fluids, then their mechanical properties, in particular their impact properties, are reduced, as well as their chemical resistance properties;
moderate impact strength, in particular in comparison with polycarbonate or nontransparent semicrystalline polyamides, in particular if these are impact modified;
often excessively high rigidity;
alternating fatigue resistance (“ross-flex”, ASTM1052);
chemical resistance markedly inferior to that of semicrystalline polyamides; and
moderate resistance to UV radiation, in particular in the absence of stabilizing agent (the addition of stabilizing agent by compounding resulting in yellowing of the polymer or the formation of black spots, which is often excessively harmful to its use in applications where an attractive appearance is important, such as, for example, frames for glasses).

One well-known improvement route for overcoming these disadvantages consists in blending the transparent amorphous polyamide with a minor amount of semicrystalline polyamide (typically nontransparent). For example, European Patents EP 550 308 and EP 725 101 disclose alloys of transparent amorphous polyamide combined with a nontransparent semicrystalline polyamide, the combination giving a transparent and amorphous or virtually amorphous material, that is to say for which the enthalpy of fusion is less than 30 J/g, indeed even 10 J/g, without real mechanical strength above its Tg and before its M.p. (melting point). Examples of materials of this type are “Cristamid MS 1100”, sold by Arkema France, or “Grilamid TR90LX”, sold by Ems. Such a type of composition exhibits the advantage of a remarkably improved chemical resistance. This composition also exhibits the advantage of being less rigid and of being less difficult to injection mould.

However, such as composition is not significantly more ductile; its ISO notched Charpy impact strength is even generally reduced with respect to that of the transparent amorphous polyamide or of the semicrystalline polyamide. For example, the Charpy AE impact test at 23° C. gives a value of 12.5 kJ/m² for Cristamid MS 1700 and a value of 8.5 kJ/m² for Cristamid MS 1100, which corresponds to an alloy of Cristamid MS 1700 with P12.

The problem which the invention intends to solve is the following:
improvement in the ability of the composition to be injection moulded, namely the ability of the composition to be easily processed by injection moulding, short cycle times, greater flow lengths, lower pressures, no distortion during the ejection of the component, no shrinkage cavity, not too many internal stresses, no breaking;
improvement in the impact strength;
reduction in the rigidity;
improvement in the resistance to chemicals and to stress cracking;
optionally, improvement in the alternating fatigue resistance and/or improvement in the resistance to UV radiation.

The Applicant has discovered that by adding, to a transparent polyamide which is amorphous or not very crystalline (A), a flexible copolyamide (B) based on amide units and on ether units, in particular based on polyamide units or blocks and on polyether units or blocks, the problem can then be effectively solved.

The composition according to the invention is composed of a blend of:
60 to 99% by weight of a constituent polymer (A) formed from at least one from

### (i) Transparent Homopolyamides and Copolyamides:

a) which are amorphous or which exhibit a crystallinity such that the enthalpy of fusion during the second heating of an ISO DSC (delta Hm(2)) is at most equal to 30 J/g, the weight being with respect to the amount of amide units present or of polyamide present, this melting corresponding to that of the amide units;
b) which exhibit a glass transition temperature (Tg) of greater than 90° C.; and
c) which are composed at least in part of cycloaliphatic and/or aromatic units,
and/or (ii) alloys based on at least one abovementioned homopolyamide or copolyamide, the said alloys being amorphous or exhibiting a crystallinity corresponding to the same definition as above; and
40 to 1% by weight of a constituent polymer formed of at least one copolyamide based on ether units and on amide units;
the constituent polymers (A)+(B) representing 100% by weight

In a first alternative form of the invention, the constituent polymer (A) represents from 80 to 97% by weight of the composition.

In a second alternative form of the invention, the constituent polymer (B) represents from 20 to 3% by weight of the composition.

Very clearly, the composition according to the invention can additionally comprise one or more additives conventional for thermoplastic polymers or copolymers, in a proportion which can range up to 15% by weight, advantageously up to 10% by weight, of the total composition then comprising the constituent polymers (A)+(B)+the various additive or additives, which can be introduced directly.

In an advantageous version of the invention, at least one of the constituent polymers from (A) and (B) can also comprise at least one additive conventional for thermoplastic polymers and copolymers, without the content of the additive or additives in each of the constituent polymers (A) and (B) representing more than 30% by weight, preferably 20% by weight, of said constituent polymer.

What is more, the problem is advantageously solved when the said copolyamide based on ether units and on amide units is itself additivated by UV stabilizers, antioxidants, mould-release agents, lubricating agents and/or processing aids.

A particularly favourable way of solving the problem is to blend the copolyamide comprising ether units and amide units, in the molten state, with the additives in question during a first stage. This first stage can take place in an extruder, the composition then being recovered in the form of granules. This composition constitutes what is referred to as a master blend. In a second stage, the composition based on copolyamide comprising ether units and amide units is blended with granules of transparent polyamide(s) which is/are amorphous or only very slightly crystalline, it being possible for this blending to be carried out in the solid state, the transparent polyamide which is amorphous or only very slightly crystalline not being remelted in the presence of air, which does not bring about the risk of harmful yellowing of the latter. This last blend constitutes the final composition according to the invention and responds to the technical problem defined above.

The various properties of the two known families of polyamide which have just been described, with which the family according to the present invention is compared, are summarized in Table 2 below.

TABLE 2

| | Comparative | Comparative | |
|---|---|---|---|
| | Example 1 | Example 2 | Invention |
| Composition | | | |
| TR amPA | 100 | 70 | 60-99 |
| TR scPA | | 30 | |
| PEBA | | | 40-1 |
| Properties | | | |
| Ability to be | + | ++ | +++ |
| injection moulded | | | |
| Impact strength | + | + | ++ |
| Flexibility | −−− | −− | − |
| Chemical | − | ++ | ++ |
| resistance | | | |
| UV stability | − | + | + |
| Transparency | +++ | +++ | ++ to +++ |

The properties are measured qualitatively with grades ranging from −−− = very poor to +++ = very good.

TR amPA or transparent amorphous PA: These are transparent materials which are amorphous or only very slightly crystalline (enthalpy of fusion during the 2nd DSC heating <30 J/g), which are rigid (ISO flexural modulus >1300 MPa) and which do not distort under heat at 60° C. as the glass transition temperature Tg is greater than 75° C. However, they are relatively non-impact-resistant, exhibiting a much lower notched Charpy ISO impact in comparison with impact-modified polyamides, and their chemical resistance is not excellent, in particular due to their amorphous nature. There also exist (but these are materials not so commonly encountered) transparent semicrystalline (or microcrystalline) polyamides typically with enthalpies of fusion during the 2nd DSC heating between 2 and 30 J/g, these materials also being fairly rigid and having an ISO flexural modulus >1000 MPa.

TR scPA or transparent semicrystalline PA: These are more specifically microcrystalline polyamides where the size of the spherolites is sufficiently great for the transparency to be low (<50% on a sheet with a thickness of 2 mm, in transmission with light at 560 nm); mention may be made, by way of examples, of polyamide-12, polyamide-11 and polyamide-6 (see European Patents EP 550 308 and EP 725 101, where such ingredients are disclosed and where they are used in conjunction and advantageously with a TR amPA).

PEBA: These are copolyamides based on ether units and on amide units: polyetheramides and in particular polyether-block-amides (PEBAs). These are very flexible impact-resistant materials but with a transparency which is fairly low (45 to 65% of light transmission at 560 nm for a thickness of 2 mm), just like their polyamide homologues without ether units.

It is observed that the composition according to the invention makes it possible to obtain materials which are both transparent and endowed with good mechanical properties, such as impact strength and relative flexibility.

The nature and the proportions of the constituent polymers (A) and (B) are preferably chosen so that the composition is transparent with a light transmission at 560 nm through a sheet with a thickness of 2 mm which is greater than 65%, in particular greater than 75%, it being known that it is not ruled out that the presence of additives such as a dark dye (black dye in particular) can reduce the transparency of the final composition.

The term “delta Hm(2)” is understood to mean the enthalpy of fusion during the second heating of a DSC according to the ISO standard, DSC being Differential Scanning Calorimetry.

In accordance with a specific embodiment of the composition according to the invention, the homopolyamides and copolyamides participating in the composition of (A) exhibit a crystallinity such that the enthalpy of fusion during the second heating of an ISO DSC (delta Hm(2)) is at most equal to 10 J/g, the weight being with respect to the amount of amide units present or of polyamide present, this melting corresponding to that of the amide units.

The homopolyamides and the copolyamides forming the constituent polymer (A) can in particular be chosen from those comprising both cycloaliphatic units and linear aliphatic units.

The homopolyamides and copolyamides simultaneously comprising cycloaliphatic units and linear aliphatic units are advantageously composed predominantly of an equimolar combination of at least one diamine and of at least one dicarboxylic acid, the diamine or diamines being predominantly cycloaliphatic and the dicarboxylic acid or acids being predominantly linear aliphatic, it being possible for the amide units optionally to comprise, but to a minor extent, at least one other polyamide comonomer.

The term “predominantly” is understood to mean “in a proportion of more than 50% by weight (>50%)”. The expression “to a minor extent” is understood to mean “in a proportion of less than 50% by weight (<50%)”.

The cycloaliphatic diamine or diamines are advantageously chosen from bis(3-methyl-4-aminocyclohexyl)methane (BMACM), para-aminodicyclohexylmethane (PACM), isophoronediamine (IPD), bis(4-aminocyclohexyl)methane (BACM), 2,2-bis(3-methyl-4-aminocyclohexyl)propane (BMACP) or 2,6-bis(aminomethyl)-norbornane (BAMN). Preferably, the cycloaliphatic diamine or diamines are chosen from BMACM, PACM and IPD.

At least one noncycloaliphatic diamine can participate in the composition of the monomers of the amide units of the constituent (A) in a proportion of at most 30 mol % is with respect to the diamines of the said composition. Mention may be made, as noncycloaliphatic diamine, of linear aliphatic diamines, such as 1,4-tetramethylene-diamine, 1,6-hexamethylenediamine, 1,9-nonamethylenediamine and 1,10-deca-methylenediamine.

The aliphatic dicarboxylic acid or acids can be chosen from aliphatic dicarboxylic acids having from 6 to 36 carbon atoms, preferably from 9 to 18 carbon atoms, in particular 1,10-decanedicarboxylic acid (sebacic acid), 1,12-dodecanedicarboxylic acid, 1,14-tetradecanedicarboxylic acid and 1,18-octadecane-dicarboxylic acid.

At least one nonaliphatic dicarboxylic acid can participate in the composition of the monomers of the amide units of the constituent (A) in a proportion of at most 15 mol % with respect to the dicarboxylic acids of the said composition. Preferably, the nonaliphatic dicarboxylic acid is chosen from aromatic diacids, in particular isophthalic acid (I), terephthalic acid (T) and their mixtures.

The monomer or monomers participating to a minor extent in the composition of the monomers of the amide units are chosen in particular from lactams and α,ω-aminocarboxylic acids.

The lactam or lactams are chosen, for example, from lactams having at least 6 carbons, in particular caprolactam, oenantholactam and lauryllactam. The α,ω-aminocarboxylic acid or acids are chosen, for example, from those having at least 6 carbons, in particular aminocaproic acid, 7-aminoheptanoic acid, 11-aminoundecanoic acid or 12-aminododecanoic acid.

The constituent polymer (A) can in particular include amide units for which the number of carbons per amide is on average at least equal to 9.

The constituent polymer (B) is advantageously chosen from PEBA copolymers composed of blocks of amide units and of sequences of ether units.

PEBA copolymers belong to the specific category of polyetheresteramides, when they result from the copoiycondensation of polyamide sequences comprising reactive carboxyl ends with polyether sequences comprising reactive ends which are polyether polyols(polyether diols), the bonds between the polyamide blocks and the polyether blocks being ester bonds, or else to the category of polyetheramides or polyether-block-amides, when the polyether sequences comprise amine ends. The two above families are included in the definition of the constituent polymer (B) according to the invention.

The PEBAs which can be used according to the present invention encompass the family where the monomers which are the source of the amide units are not solely aliphatic monomers (such as the Pebax products, series 33, 13, 31 and 11, from Arkema, the Vestamid products and the Ubesta products) but also, at least partially, cycloaliphatic monomers, indeed even aromatic monomers, examples of which are BMACM.14/PTMG.14, where the BMACM.14 unit has a weight of 2000 g/mol and where the PTMG unit has a weight of 650 g/mol.

The ether units or sequences of the constituent polymer (B) result, for example, from at least one polyalkylene ether polyol, in particular a polyalkylene ether diol, preferably chosen from polyethylene glycol (PEG), polypropylene glycol (PPG), polytrimethylene glycol (PO3G), polytetramethylene glycol (PTMG) and their blends or their copolymers.

The polyether blocks can also comprise, as indicated above, polyoxyalkylene sequences comprising NH₂ chain ends, it being possible for such sequences to be obtained by cyanoacetylation of α,ω-dihydroxylated aliphatic polyoxyalkylene sequences referred to as polyether diols. More particularly, it will be possible to use

Jeffamines (for example, Jeffamine® D400, D2000, ED 2003 or XTJ 542, commercial products from Huntsman. See also Patents JP 2004346274, JP 2004352794 and EP1482011).

The amide units or blocks of the constituent copolymer (B) can in particular be residues of linear aliphatic monomers, such as:
linear aliphatic diamines, such as 1,4-tetramethylenediamine, 1,6-hexamethylene-diamine, 1,9-nonamethylenediamine and 1,10-decamethylenediamine;
aliphatic dicarboxylic acids which can be chosen from aliphatic dicarboxylic acids having from 6 to 36 carbon atoms, preferably from 9 to 18 carbon atoms, in particular 1,10-decanedicarboxylic acid (sebacic acid), 1,12-dodecanedicarboxylic acid, 1,14-tetradecanedicarboxylic acid and 1,18-octadecanedicarboxylic acid;
lactams, such as caprolactam, oenantholactam and lauryllactam; and
α,ω-aminocarboxylic acids, such as aminocaproic acid, 7-aminoheptanoic acid, 11-aminoundecanoic acid or 12-aminododecanoic acid.

Mention may be made, as PEBA copolymers which are particularly preferred for the constituent polymer (B) of the composition according to the present invention, of those composed of amide units which are residues of linear aliphatic monomers and of polyether sequences of PTMG, PPG or PEG type, it being possible for the residues of linear aliphatic monomers in particular to be residues of a diamine and of a diacid.

For the PEBAs which can be used as constituent (B) according to the invention, the number-average molecular weight of the polyimide blocks is advantageously between 500 and 12 000 g/mol, preferably between 2000 and 6000 g/mol; and the number-average molecular weight of the sequences of ether units is advantageously between 200 and 4000 g/mol, preferably between 300 and 1100 g/mol.

Furthermore, the constituent polymer (B) can advantageously include amide units for which the number of carbons per amide is on average at least equal to 9.

The amide units of the constituent polymer (B) can represent 50 to 95% by weight of the said constituent polymer (B).

Flexible PEBA copolyamides which may be particularly used are the PEBAs 5533, 6333 and 7033 sold by Arkema France and the PEBAs Vestamid E62-S3, E55-S3 and E47-S3 sold by Degussa. In particular, mention is made of the PEBAs sold by Degussa and the PEBAs Ubesta XPA 9063X1, 9055X1, 9055X2 and 9044X2 sold by Ube, which are based on polyethers (and their blends) comprising NH₂ chain ends of Jeffamine type.

The additive or additives introduced into the composition or into the constituent polymer (A) and/or the constituent polymer (B) are chosen from catalysts, in particular those based on phosphorus, UV stabilizers, colorants, nucleating agents, plasticizers, agents for improving the impact strength, antioxidants, mould-release agents or processing aids, the said additives preferably having a refractive index similar to that of the said constituent polymer (B) of the said composition.

The mould-release agents and the processing aids are chosen in particular from stearates, such as calcium stearate, zinc stearate and magnesium stearate, fatty acids, fatty alcohols, esters of montan ester type, sebacic acid esters, dodecanedioic acid esters, polyolefin waxes, amide waxes, stearamides, such as ethylenebisstearamide (EBS), erucamides or fluorinated additives, in particular of Dyneon Dynamer FX 5914 or FX 5911 type.

Furthermore, the nature and the proportions of the constituent polymers (A) and (B) are advantageously chosen so that the resulting composition exhibits a glass transition temperature at least equal to 75° C.

Equally, the nature and the proportions of the constituent polymers (A) and (B) are advantageously chosen in order for the composition to exhibit a high transparency such that the transmission at 560 nm through a sheet with a thickness of 2 mm is greater than 75%, it being known that it is not ruled out that the presence of additives such as a dark dye (in particular black dye) can reduce the transparency of the final composition.

In accordance with other advantageous characteristics of the present invention, in order to obtain a final transparent composition with a transmission of greater than 65%, preferably of greater than 75%, under the conditions indicated above, the constituents (A) and (B) are chosen so that:
n being the number of carbons per amide group of the transparent amorphous constituent polymer (A); and
m being the number of carbons per amide group of the part of the units resulting from residues of polyamide monomers of the constituent polymer (B),
   then n≧m≧n/2; and/or
the refractive index of the constituent polymer (A) and that of the constituent polymer (B) are chosen to be as close as possible to one another, that is to say, that the difference between the two refractive index values is less than 0.004 and preferably less than 0.002; and/or
the density of the constituent polymer (A) and that of the constituent polymer (B) are chosen to be as close as possible to one another, that is to say, that the difference between the two density index values is less than 0.07 and preferably less than 0.03.

A specific form of the present invention consists in choosing a composition characterized in that its flexible ether units are chosen to be of highly hydrophilic nature, preferably of polyether block of PEG, PPG or PO3G type nature, which confers an advantageous increase in antistatic and waterproof-breathable properties on the composition (that is to say, allowing the passage of water vapour but not of liquid water). It is furthermore possible for this composition to be additivated by third-party antistatic additives, in order to strengthen the overall antistatic effect, and also by additives which make it possible to increase the blending compatibility with other polymers, it being possible for the copolymer, alone or thus additivated, subsequently to be used as additive of another polymer or material in order to confer, on the latter, an increase in antistatic or waterproof-breathable properties, that is to say, allowing the passage of water vapor but not of liquid water,

The following procedure is generally used to prepare the compositions according to the invention:

The constituents (A) and (B), which are in the form of granules, are blended together. This blend is subsequently injection moulded at a temperature generally of is between 230° C. and 330° C., in particular at a temperature of approximately 270° C., on an injection-moulding machine in order to produce the desired objects and test specimens. Operating at a higher temperature than 330° C. can improve the transparency but this has the disadvantage of giving greater yellowing and of decomposing the product. A compromise is thus desirable.

It is also possible to blend the constituents (A) and (B) in the molten state, in particular in an extruder, such as a twin-screw extruder, at a temperature of between 230° C. and 330° C., in particular at a temperature of approximately 270° C., and they are recovered in the form of granules, which granules will subsequently be injection moulded at a temperature of between 230° C. and 330° C. on an injection-moulding machine in order to produce the desired objects and test specimens.

In a specific embodiment of this process where the composition comprises additives in the constituent (B):
in a first stage, the constituent (B) is blended in the molten state with the said additives, in particular in an extruder, the composition then being recovered in the form of granules;
in a second stage, the composition obtained in the first stage is blended with granules of the constituent polymer (A).

Another subject-matter of the present invention is a shaped article, in particular a transparent or translucent shaped article, such as fibre, fabric, film, sheet, rod, pipe or injection-moulded component, comprising the composition as defined above.

Thus, the composition according to the present invention is advantageous in the ready manufacture of articles, in particular of sports equipment or components of sports equipment, which have in particular to simultaneously exhibit good transparency, good impact strength and good endurance with regard to mechanical assaults and attacks by chemicals, UV radiation and heat. Mention may be made, among this sports equipment, of components of sports shoes, sports gear, such as ice skates or other winter and mountaineering sports equipment, ski bindings, rackets, sports bats, boards, horseshoes, flippers, golf balls or recreational vehicles, in particular those intended for cold-weather activities.

Mention may also be made generally of recreational equipment, do-it-yourself equipment, highway gear and equipment subjected to attacks by the weather and to mechanical assaults, or protective articles, such as helmet visors, glasses and sides of glasses. Mention may also be made, as nonlimiting examples, of motor vehicle components, such as headlight protectors, rearview mirrors, small components of all-terrain motor vehicles, tanks, in particular for mopeds, motorbikes or scooters, subjected to mechanical assaults and attacks by chemicals, screws and bolts, cosmetic articles subjected to mechanical assaults and attacks by chemicals, lipstick tubes, pressure gauges or attractive protective components, such as gas bottles.

The following examples (see Table 3 below) illustrate the present invention without, however, limiting the scope thereof. In the examples or comparative examples, the percentages are by weight, unless otherwise indicated. The following abbreviations were used:
P.T/12: transparent amorphous polyamide, the molar composition of which is 1 mol of P, 1 mol of T and 1.2 mol of 12. P is the diamine PACM, T is terephthalic acid and 12 is lactam 12. PACM is 4,4′-diaminodicyclohexyl-methane.
B.14: transparent amorphous polyamide, the molar composition of which is 1 mol of B and 1 mol of 14. B is the diamine BMACM and 14 is the linear C14 diacid tetradecanedioic acid.
PEBA1: copolymer comprising copolyamide 12 block with a weight of 2000 g/mol and comprising PTMG polyether block with a weight of 1000 g/mol.
PEBA2: copolymer comprising copolyamide 12 block with a weight of 4000 g/mol and comprising PTMG polyether block with a weight of 1000 g/mol.
PEBA3: copolymer comprising copolyamide 12 block with a weight of 5000 g/mol and comprising PTMG polyether block with a weight of 650 g/mol.
PEBA-H: composition based on PEBA2 to which are added 8.4% of UV stabilizer Tinuvin 350 (Ciba), 8.4% of Tinuvin 770 (Ciba), 9.75% of antioxidant Irganox 1010 (Ciba) and 11.2% of dioctadecyl pentaerythritol bis(phosphite).
PEBA-L: composition based on PEBA2 to which 14.3% of calcium stearate are added.
PEBA-E: composition based on PEBA2 to which 14.3% of EBS (ethylenebisstearamide) are added.
PA11: polyamide 11 with a weight-average molecular weight of between 45 000 and 55 000 g.

The following tests were carried out on the compositions of the comparative examples or examples of Table 3.
Test of ability to be injection moulded: The compositions are injection moulded at 260° C. in a spiral mould with a thickness of 2 mm at a given pressure (600 bar or 1200 bar). The length which the molten material was able to fill is subsequently measured (in mm).
Impact test or bending test: The test was carried out in the following way. 80×10×4 mm bars are moulded by injection moulding in an ISO mould. The bar is bent quickly by 180° at the injection gate, between the bar and the cluster, at the point where the thickness is reduced to approximately 1 mm. The number of clean breaks is subsequently measured over a series of 20 bars and is expressed as percentage of breakage.
Notched Charpy impact test: The test is carried out according to Standard ISO179 on a notched test specimen, the notch being V-shaped and 0.25 mm in width.
Chemical resistance test: Dumbbells with a thickness of 2 mm are bent by 180° and are immersed in various solutions increasingly concentrated in ethanol. The ethanol concentration is expressed as %. It is observed whether the dumbbell has broken or split. The most concentrated solution which has not resulted in breaking or splitting is selected as criterion. The higher the figure, the better the material.
Flexibility test: The flexibility is described by the measurement of the flexural modulus according to Standard ISO178. It is expressed in MPa. The lower the modulus, the more flexible or pliable the composition.
UV stability: It is evaluated using a QUV test. The yellowing is compared with respect to the sample in the initial state.
Transparency: It is described by a test of light transmission of light of 560 nm through a polished sheet with a thickness of 2 mm. It is expressed as percentage of transmission. Above 65%, the transparency is good. Above 80%, it is very good. Above 88%, it is excellent. The most transparent polymer has a value of approximately 92%.

TABLE 3

| | | TEST OF ABILITY | | | | | | | CHARPY |
|---|---|---|---|---|---|---|---|---|---|
| | | TO BE INJECTION | | IMPACT | | | | | IMPACT |
| | | MOULDED | | TEST | CHEMICAL | FLEXIBILITY | UV | | ISO179 |
| | | Pressure | Pressure | % Breakage on | RESISTANCE | Modulus | STABILITY | | 0.25 mm |
| | | 600 bars | 1200 bars | bending | Ethanol | ISO178 | 500 h, QUV | TRANSPARENCY | notch |
| | | mm | mm | % | % | MPa | % | 560 nm; 2 mm | kJ/m² |
| Comp. a | P.T/12 | 50 | 142 | 50% | 92 | 1620 | | 90 | |
| Ex. a | P.T/12 + 5% | 78 | 179 | 25% | 94 | 1480 | turned | 86 | |
| | PEBA1 | | | | | | yellow | | |
| Ex. b | P.T/12 + 3.5% | 89 | 194 | 30% | 94 | 1525 | turned | 85 | |
| (outside | PEBA-H | | | | | | yellow | | |
| Claim 1) | | | | | | | | | |
| Ex. c | P.T/12 + 3.5% | 77 | 186 | 30% | 94 | | turned a little | 84 | |
| | PEBA-L | | | | | | yellow | | |
| Ex. d | P.T/12 + 3.5% | 106 | 162 | 35% | 94 | | | 86 | |
| | PEBA-E | | | | | | | | |
| Comp. b | B.14 | 38 | 109 | 40% | 90 | 1375 | | 91 | 10.2 |
| Comp. c | B.14 + 30% | 54 | 144 | 40% | 97 | 1280 | | 91 | |
| | PA11 | | | | | | | | |
| Ex. e | B.14 + 20% | 112 | 188 | 0% | 95 | 1150 | | 70 | 4.05 |
| | PEBA1 | | | | | | | | |
| Ex. f | B.14 + 20% | 96 | 198 | 25% | 96 | 1280 | | 87 | 16.8 |
| | PEBA2 | | | | | | | | |
| Ex. g | B.14 + 15% | 99 | 187 | 0% | 97 | 1240 | | 88 | 13 |
| | PEBA3 + 5% | | | | | | | | |
| | PEBA1 | | | | | | | | |
| Ex. h | B.14 + 30% | | | 0% | 99 | 1130 | | 79 | |
| | PEBA2 | | | | | | | | |
| Ex. i | B.14 + 10% | | | 0% | 92 | 1290 | | 83 | 14.8 |
| | PEBA1 | | | | | | | | |
| Ex. j | B.14 + 10% | | | 0% | 93 | 1323 | | 87 | 11.6 |
| | PEBA2 | | | | | | | | |
| Ex. l | B.14 + 10% | | | 0% | 94 | 1350 | | 90 | 10.7 |
| | PEBA3 | | | | | | | | |

Values for Charpy impact tests at −30° C. with a broad U-shaped notch with a width of 1 mm are shown in table 4 below. It represents the bending impact test.

TABLE 4

| | | | | | |
|---|---|---|---|---|---|
| B.14 (Rilsan Clear G350) | 90 | 85 | 80 | 80 | 100 |
| PEBA1 | 10 | 15 | 20 | | |
| PEBA2 | | | | 20 | |
| Charpy impact, −30° C., 1 mm notch | 69.9 | 92.8 | 113 | 79.2 | 9.6 |
| Standared deviation | 19.3 | 9.8 | 5.9 | 10 | 1.3 |
| Transparency, 2 mm, 560 nm: % | 90.5 | 78 | 73 | 88 | 91 |

The very large increase with regard to impact by virtue of the use of the compositions in accordance with the invention is thus observed.

1. Composition composed of a blend of:
60 to 99% by weight of a constituent polymer (A) formed from at least one
(i) transparent homopolyamides and copolyamides:
a) which are amorphous or which exhibit a crystallinity such that the enthalpy of fusion during the second heating of an ISO DSC (delta Hm(2)) is at most equal to 30 J/g, the weight being with respect to the amount of amide units present or of polyamide present, this melting corresponding to that of the amide units;
b) which exhibit a glass transition temperature (Tg) of greater than 90° C.; and
c) which are composed at least in part of cycloaliphatic and/or aromatic units,
and/or (ii) alloys based on at least one abovementioned homopolyamide or copolyamide, the said alloys being amorphous or exhibiting a crystallinity corresponding to the same definition as above in (a); and
40 to 1% by weight of a constituent polymer (B) formed of at least one copolyamide based on ether units and on amide units;
the constituent polymers (A)+(B) representing 100% by weight; wherein at least one from (A) and (B) may optionally further comprise at least one additive conventional for thermoplastic polymers and copolymers, wherein the content of the additive or additives in each of the constituent polymers (A) and (B) represents no more than 30% by weight of the said constituent polymer.

2. Composition according to claim 1, wherein the constituent polymer (A) represents 80 to 97% by weight of the composition and the constituent polymer (B) represents 20 to 3% by weight of the composition.

3. Composition according to claim 1, wherein the nature and the proportions of the constituent polymers (A) and (B) are chosen so that the composition is transparent with a light transmission at 560 nm through a sheet with a thickness of 2 mm which is greater than 65%.

4. Composition according to claim 1, wherein the homopolyamides and copolyamides participating in the composition of the constituent polymer (A) exhibit a crystallinity such that the enthalpy of fusion during the second heating of an ISO DSC (delta Hm(2)) is at most equal to 10 J/g, the weight being with respect to the amount of amide units present or of polyamide present, this melting corresponding to that of the amide units.

5. Composition according to claim 1, wherein the homopolyamides and the copolyamides forming the constituent polymer (A) are chosen from those comprising both cycloaliphatic units and linear aliphatic units.

6. Composition according to claim 5, wherein the homopolyamides and copolyamides simultaneously comprising cycloaliphatic units and linear aliphatic units are composed predominantly of an equimolar combination of at least one diamine and of at least one dicarboxylic acid, the diamine or diamines being predominantly cycloaliphatic and the dicarboxylic acid or acids being predominantly linear aliphatic, it being possible for the amide units optionally to comprise, but to a minor extent, at least one other polyamide comonomer.

7. Composition according to claim 6, wherein the cycloaliphatic diamine or diamines are chosen from bis(3-methyl-4-amino-cyclohexyl)methane (BMACM), para-aminodicyclohexylmethane (PACM), isophoronediamine (IPD), bis(4-aminocyclohexyl)methane (BACM), 2,2-bis(3-methyl-4-aminocyclohexyl)propane (BMACP) and 2,6-bis(aminomethyl)norbornane (BAMN).

8. Composition according to claim 6 wherein the aliphatic dicarboxylic acid or acids are chosen from aliphatic dicarboxylic acids having from 6 to 36 carbon atoms.

9. Composition according to g claim 1, wherein the constituent polymer (A) includes amide units for which the number of carbons per amide is on average at least equal to 9.

10. Composition according to claim 1, wherein the constituent polymer (B) is chosen from polyether-block-amide (PEBA) copolymers composed of blocks of amide units and of sequences of ether units.

11. Composition according to claim 10, wherein the PEBA copolymers are chosen from polyetheresteramides and polyether-block-amides.

12. Composition according to claim 1, wherein the ether units of the constituent polymer (B) result from at least one polyalkylene ether polyol.

13. Composition according to claim 12, wherein the polyalkylene ether diol is chosen from polyethylene glycol (PEG), polypropylene glycol (PPG), polytrimethylene glycol (PO3O), polytetramethylene glycol (PTMG) and their blends or their copolymers.

14. Composition according to one of claim 1, wherein the constituent polymer (B) is composed of amide units which are residues of linear aliphatic monomers and of polyether sequences of PTMG, PPG or PEG type.

15. Composition according to claim 1, wherein the number-average molecular weight of the polyamide blocks is between 500 and 12 000 g/mol.

16. Composition according to claim 1, wherein the number-average molecular weight of the sequences of ether units is between 200 and 4000 g/mol, preferably between 300 and 1100 g//mol.

17. Composition according to claim 1, wherein the constituent polymer (B) includes amide units for which the number of carbons per amide is on average at least equal to 9.

18. Composition according to claim 1, wherein the amide units of the constituent polymer (B) represent 50 to 95% by weight of the said constituent polymer (B).

19. Composition according to claim 1, wherein the additive or additives are selected from the group consisting of catalysts, phosphorus based catalysts, UV stabilizers, colorants, nucleating agents, plasticizers, agents for improving the impact strength, antioxidants, antistatic agents, mould-release agents and processing aids, the said additives preferably having a refractive index similar to that of the said constituent polymer (B) of the said composition.

20. Composition according to one of claim 1, wherein the nature and the proportions of the constituent polymers (A) and (B) are chosen so that the resulting composition exhibits a glass transition temperature equal to or greater than 75° C.

21. Composition according to claim 1, wherein the constituent polymers (A) and (B) are chosen so that:
n being the number of carbons per amide group of the transparent constituent polymer (A); and
m being the number of carbons per amide group of the part of the units resulting from residues of polyamide monomers of the constituent polymer (B),
then n≧m≧n/2.

22. Composition according to claim 1, wherein the difference between the refractive index values of the constituent polymers (A) and (B) is less than 0.004.

23. Composition according to claim 1, wherein the difference between the density values of the constituent polymers (A) and (B) is less than 0.07.

24. Process for the manufacture and use of the composition as claim 1, comprising the steps of blending the constituent polymers (A) and (B), which are in the form of granules, and, if appropriate, the additive or additives and subsequently injection molding said granular blend at a temperature of between 230 and 330° C. on an injection-moulding machine to produce objects and test specimens.

25. Process according to claim 24, wherein
in a first stage, the constituent polymer (B) is blended in the molten state with the additive or additives, in an extruder, the composition then being recovered in the form of granules;
in a second stage, the composition obtained in the first stage is blended with granules of the constituent polymer (A).

26. Process for the manufacture of the composition defined of claim 1 comprising the steps of blending the constituent polymers (A) and (B), in the molten state, and, if appropriate, the additive or additives, in an extruder, at a temperature of between 230 and 330° C., recovering said blend in the form of granules, and subsequently injection molding said granular blend at a temperature of between 230 and 330° C. in order to produce objects and test specimens.

27. The process of claim 24, wherein said object and test specimen is a transparent or translucent shaped article, fibre, fabric, film, sheet, rod, pipe or injection-moulded component.
